(19) United States
(12) Patent Application Publication
(10) Pub. No.: US 2008/0044786 A1
(43) Pub. Date: Feb. 21, 2008

(54) Orthodontic repositioning appliance

(76) Inventor: Tom Kalili, Beverly Hills, CA (US)

Correspondence Address: BANNER & WITCOFF, LTD., TEN SOUTH WACKER DRIVE, SUITE 3000, CHICAGO, IL, 60606, US

(21) Appl. No.: 11/549,506

(22) Filed: Oct. 13, 2006

Related U.S. Application Data
(60) Provisional application No. 60/822,991, filed on Aug. 21, 2006.

(51) Int. Cl. A61C 3/00

(52) U.S. Cl. 433/6

(57) ABSTRACT

The invention relates to an invisible removable orthodontic repositioning appliance with a lower modulus inner lining for systematically aligning teeth from an initial tooth arrangement to a final tooth arrangement while minimizing propensity for root and bone resorption due to the lower modulus. The aligning of the teeth may be accomplished by taking impressions at various intervals for greater accuracy in the event of a distorted impression. Patient impression and/or model may then be digitally scanned. Using 3D software, tooth position may be incrementally modified toward idealized position and associated stress analyzed. Final modified model and associated appliance may be fabricated with for orthodontic movement using 3D printer. Each appliance may be numerically identified to maintain uniformity of application from start of treatment to completion. The forces required for the alignment may be from polymeric material used to fabricate the orthodontic appliances, the shape memory alloy, and/or micro-implants with various attachments, including magnetic attachments to allow for three potential types of cooperating forces toward optimal tooth movement.

This application claims the benefit of U.S. Provisional Application No. 60/822,991 filed Aug. 21, 2006, which is incorporated herein by reference in its entirety.

### BACKGROUND

Orthodontic treatments involve repositioning misaligned teeth and improving bite configurations for improved cosmetic appearance and dental function. Repositioning teeth is accomplished by applying controlled forces to the teeth over an extended period of time.

Currently, there are numerous techniques for orthodontic treatments for repositioning misaligned teeth and improving bite configurations. The conventional technique consists of requiring the patient to wear what are commonly referred to as “braces.” Braces comprise a variety of appliances such as brackets, bands, arch wires, ligatures, and O-rings. After they are bonded to the teeth, periodic meetings with the orthodontist are required to adjust the braces. This involves installing different arch wires having different force-inducing properties or by replacing or tightening existing ligatures. Between meetings, the patient may be required to wear supplementary appliances, such as elastic bands or headgear, to supply additional or extra oral forces. Conventional braces are often a tedious and time consuming process requiring many visits to the orthodontist's office. Moreover, from a patient's perspective, they are unsightly and uncomfortable.

Another group of appliances are removable orthodontic appliances, which have been used since the early 20th century. One such appliance in this group is a tooth positioning appliance, as disclosed in U.S. Pat. No. 2,531,222. The tooth positioning appliance is one piece that moves the upper and lower teeth simultaneously. This type of appliance is very demanding on patients as it is bulky, uncomfortable, and prevents patients from speaking. Also in this group are appliances known as spring-alignment appliances. These appliances are designed to correct minor incisor rotations. This appliance is constructed over a model of the repositioned teeth. Labial and lingual wires are formed and labial and lingual plates are formed over the wires. The acrylic plates apply the pressure to the teeth. These appliances cannot be adjusted and are not particularly effective for tooth movement.

Consequently, alternative orthodontic treatments have been developed. Recent patents, including U.S. Pat. No. 6,454,565 by inventor Phan and U.S. Pat. No. 6,790,036 by inventor Graham relies on the use of elastic positioning appliances for realigning teeth. In these alternative treatments an inner elastic modulus is significantly higher then the outer elastic modulus thereby creating greater potential for excess and localized force which in turn possesses greater propensity to cause iatrogenic damage to patient's teeth, dental roots, and periodontum. Although during routine orthodontic dental movement it is necessary to cause some resorption and apposition, otherwise teeth cannot move, one must limit such degradation of anatomical structure to thereby minimize the ultimate loss of teeth. The increased modulus to the inner aspect of the appliance does the opposite of what a periodontist (specialist in bone, soft tissue and dental health) wishes for any patient. Thus, there is a need in the art for an apparatus and method providing orthodontic treatments without causing periodontal destruction which is not necessary for dental movement.

### SUMMARY

The summary is provided to introduce a selection of concepts in a simplified form that are further described below in the detailed description. This summary is not intended to identify key features or essential features of the subject matter, nor is it intended to be used to limit the scope of the subject matter.

An aspect of the invention relates to an invisible removable orthodontic repositioning appliance with a lower modulus inner lining for systematically aligning teeth from an initial tooth arrangement to a final tooth arrangement while minimizing propensity for root and bone resorption.

In another aspect of the invention relates to an invisible removable orthodontic repositioning appliance with an option to have incorporated in it Shape Memory Alloy (SMA) which is an alloy used in the aeronautic industry where once the material shape is set the material may be severely deformed and then returned to its original shape.

In another aspect of the invention, a repositioning appliance may be constructed from polymers with a lower elastic modulus inner lining than an outer lining. The lower elastic modulus on the inner layer may allow for greater patient comfort, less tooth, bone and root damage, and longer duration of active tooth movement by the repositioning appliance thereby requiring less number of appliances to achieve idealized alignment.

In another aspect of the invention, a separate repositioning appliance may be made for a patient's upper, maxillary, teeth or for a patient's lower, mandibular, teeth.

In an additional aspect of the invention, a separate mold may be taken of the patient's teeth at various intervals in the alignment process, and a new repositioning appliance may be made based on such molds. By creating numerous molds, a defect in one mold may not continue throughout the course of the patient's treatment. Each of the molds and associated appliances may be numerically identified to maintain uniformity of application from start of treatment to completion.

In a further aspect of the invention, the repositioning appliance may comprise bars for greater control and attachment over a patient's teeth. The bars may be longitudinal, diagonal, or horizontal depending upon the type of orthodontic movement. The bars are achieved by placing grooves at the desired locations on the patient's model and upon fabrication of the repositioning appliance, grooves on the model would be translated into bars on the appliance.

### BRIEF DESCRIPTION OF THE DRAWINGS

FIG. 1 illustrates an occlusal view of a maxillary impression taken from a patient with anterior crowding prior to any treatment in accordance with an aspect of the invention.

FIG. 2 illustrates an occlusal view of a maxillary stone model which has been poured from the maxillary impression in accordance with an aspect of the invention.

FIG. 3 illustrates an occlusal view of a maxillary repositioning appliance which has been fabricated from the modified stone model referenced in FIG. 2 in accordance with an aspect of the invention.

FIG. 4 illustrates an occlusal view of the repositioning appliance on the maxillary model referenced in FIG. 2 in accordance with an aspect of the invention.

FIG. 5 illustrates an occlusal view of the maxillary stone model in FIG. 2, where the anterior teeth have been sequentially modified toward their idealized tooth position in accordance with an aspect of the invention.

FIG. 6 illustrates an occlusal view of a mandibular impression taken from a patient with anterior crowding in accordance with an aspect of the invention.

FIG. 7 illustrates an occlusal view of the mandibular stone model which has been poured from the mandibular impression, referenced in FIG. 6 in accordance with an aspect of the invention.

FIG. 8 illustrates an occlusal view of the mandibular repositioning appliance which has been fabricated from the modified stone model in accordance with an aspect of the invention.

FIG. 9 illustrates an occlusal view of the repositioning appliance on the mandibular model referenced in FIG. 7 in accordance with an aspect of the invention.

FIG. 10 illustrates an occlusal view of the mandibular stone model in FIG. 7, where the anterior teeth have been slightly modified toward their idealized positions in accordance with an aspect of the invention.

FIG. 11 illustrates an occlusal diagrammatic view of a patient's maxillary teeth where the anterior teeth have been sequentially aligned in accordance with an aspect of the invention.

FIG. 12 illustrates an occlusal diagrammatic view of a patient's maxillary teeth of FIG. 11 following use of the repositioning appliance where the anterior teeth have been partially aligned from a subsequent patient impression in accordance with an aspect of the invention.

FIG. 13 illustrates an occlusal diagrammatic view of a patient's mandibular teeth of where the anterior teeth have been partially aligned, in accordance with an aspect of the invention.

FIG. 14 illustrates an occlusal diagrammatic view of a patient's mandibular teeth of FIG. 13 following the use of the repositioning appliance where the anterior teeth have been partially aligned from a subsequent patient impression in accordance with an aspect of the invention.

FIGS. 15 and 16 illustrate schematic drawings representing the difference between low modulus (softer) inner aspects of the appliance compared to a higher modulus (harder) appliance at the tooth—appliance interface in accordance with an aspect of the invention.

FIG. 17 illustrates stress distributions in laminated and un-laminated repositioning appliances in accordance with an aspect of the invention.

FIG. 18 illustrates grooves that may be used in various embodiments of a repositioning appliance in accordance with an aspect of the invention.

### DETAILED DESCRIPTION

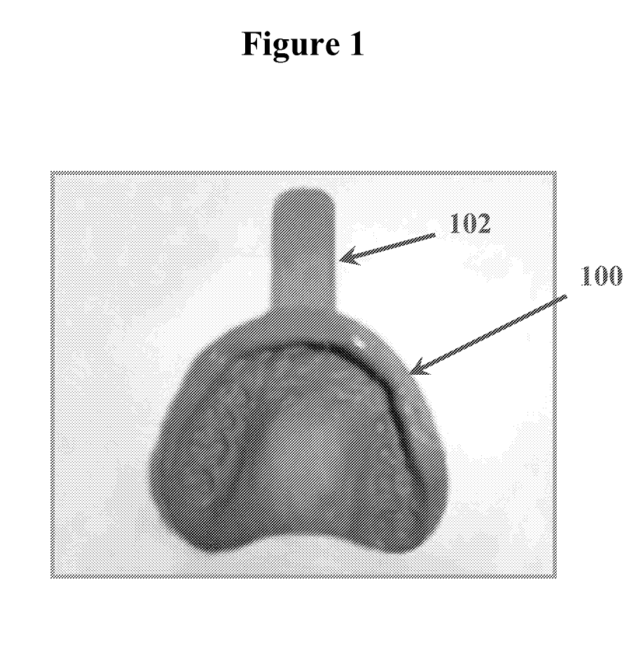

FIG. 1 illustrates an occlusal view of a maxillary impression 100 taken from a patient with anterior crowding. A maxillary impression 100 is an impression made of a patient's upper teeth. Anterior crowding is crowding of the front teeth. The maxillary impression 100 may be removed from the patient's mouth using tab 102.

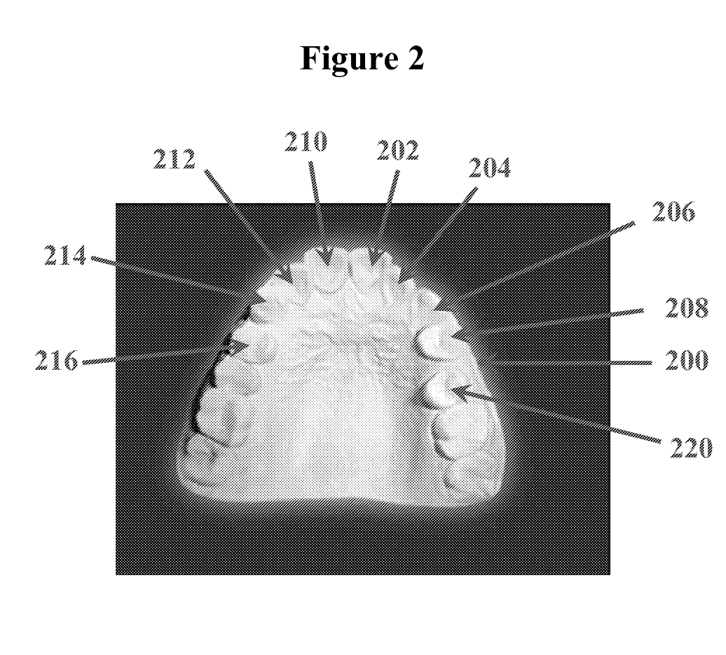

A maxillary stone model 200 of the patient's maxillary teeth may be made using the maxillary impression 100, as seen in FIG. 2. The stone model 200 of the maxillary impression 100 may be modified to create an appliance that will alter and align the patient's teeth. In FIG. 2, the anterior teeth 202, 204, 206, 208, 210, 212, 214, 216, and posterior (rear) tooth 220 are not aligned.

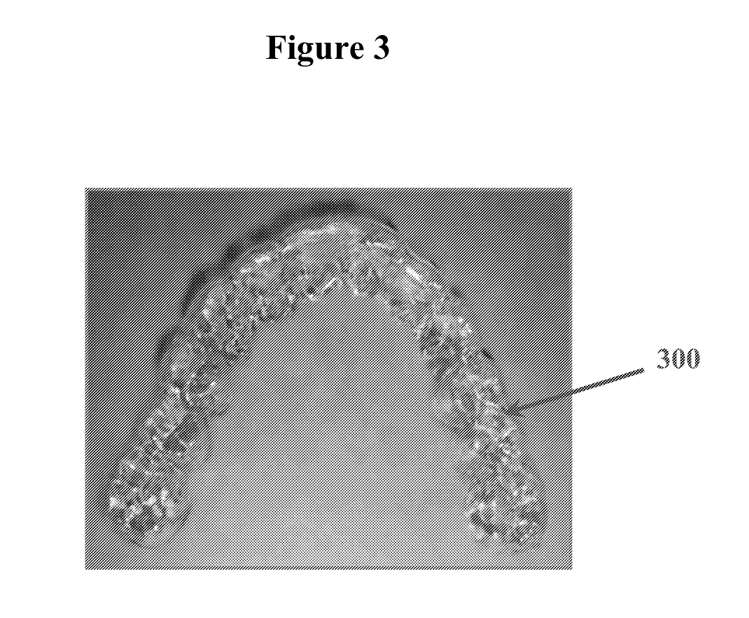

FIG. 3 illustrates maxillary repositioning appliance 300 that may be fabricated from a maxillary stone model. Maxillary repositioning appliance 300 may be the first repositioning appliance in a series of appliances that may be used to reach the alignment goal. Repositioning appliance 300 may be comprised of a single sheet of material that may be formed from a variety of materials, such as polymers and plastics including polycarbonates, polyacetates, polyolefins, polyamides, polystyrenes and epoxy resins among others. These materials may range in thickness from 0.020 inch to 0.080 inch, depending upon the material's physical characteristics. In an aspect of the invention, repositioning appliance 300 may be 0.030 inch thick polycarbonate with a lower modulus inner lining which has been thermo vacuum-formed over a model 406 of a patient's teeth. The polycarbonate with a lower modulus inner lining is tissue compatible and invisible making it aesthetically appealing to the patient during use. Those skilled in the art will realize that materials such as polycarbonates, polyacetates, polyolefins, polyamides, polystyrenes and epoxy resins among others also may be provided in clear forms. The 0.030 inch repositioning appliance 300 may be firm enough to move the patient's teeth and may be flexible enough to adapt to the patient's misaligned teeth. These characteristics may provide a sequential adjustment of the teeth from a new impression at each and every phase toward the ideal that will move the patient's teeth from misalignment to alignment on an incremental basis with each and every new impression taken at each treatment interval of about six weeks. Those skilled in the art will realize that treatment intervals may be shorter or longer than six weeks depending upon a variety of patient and treatment factors.

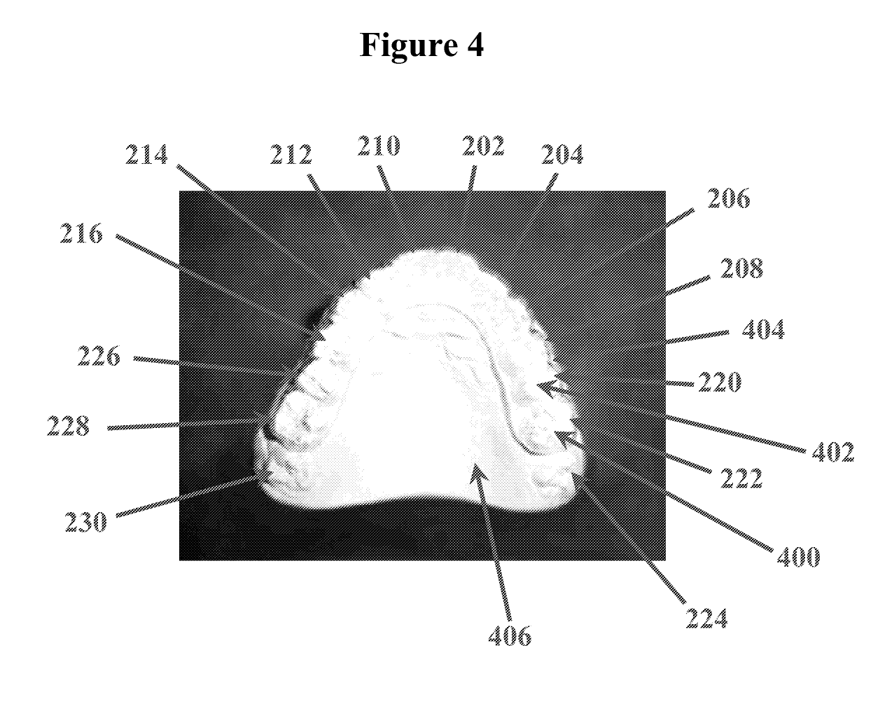

FIG. 4 illustrates maxillary repositioning appliance 300 over modified maxillary stone model 406. As shown in FIG. 4, maxillary repositioning appliance 300 does not have to extend over all maxillary teeth 400. Repositioning appliance 300 may be formed over a patient's teeth 402 and adjacent soft tissue 404. In an aspect of the invention, repositioning appliance 300 may have its best use when only the anterior teeth 202, 204, 206, 208, 210 212, 214, 216 require aligning and the posterior teeth 220, 222, 224, 226, 228, 230, requiring no alignment, become an anchor for the repositioning appliance 300. In an alternative embodiment, with other teeth acting as an anchor, the repositioning appliance 300 may be used to align posterior teeth 220, 222, 224, 226, 228, 230.

The process of taking a maxillary impression, creating a stone model therefrom, modifying that stone model to form a more ideal teeth alignment model, and creating a maxillary repositioning appliance may occur about every six weeks until the patient's teeth are in alignment.

In an aspect of the invention, the repositioning appliance may be created using a 3-D scanner and printer. When using 3-D technology to fabricate a repositioning appliance, there may be greater accuracy using laminated aligners with soft inner lining then un-laminated aligners as the repositioning appliance with laminated soft liners demonstrates less stress in the supporting bone then un-laminated aligners when inserting over an un-orthodontically altered model.

In an aspect of the invention, posterior teeth 220, 222, 224, 226, 228, 230 which may not require alignment may act as anchors for repositioning appliance 300 for use in aligning anterior teeth 204, 206, 208, 210, 212, 214, and 216.

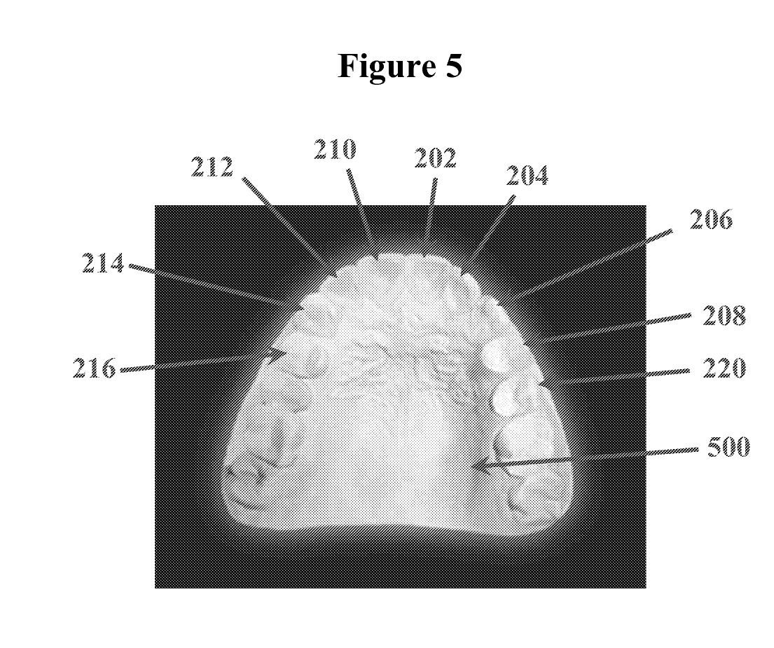

FIG. 5 illustrates a maxillary stone model 500, which has been sequentially modified from an impression made subsequent to use of a number of repositioning appliances, each designed to increasingly align the patient's teeth. As shown on stone model 500, the patient's teeth 202, 204, 206, 208, 210, 212, 214, 216, 220 are much more aligned than they had been in the initial modified maxillary stone model 200. Maxillary stone model 500 has been modified to a more ideal alignment, and it may be used to create a subsequent maxillary repositioning appliance.

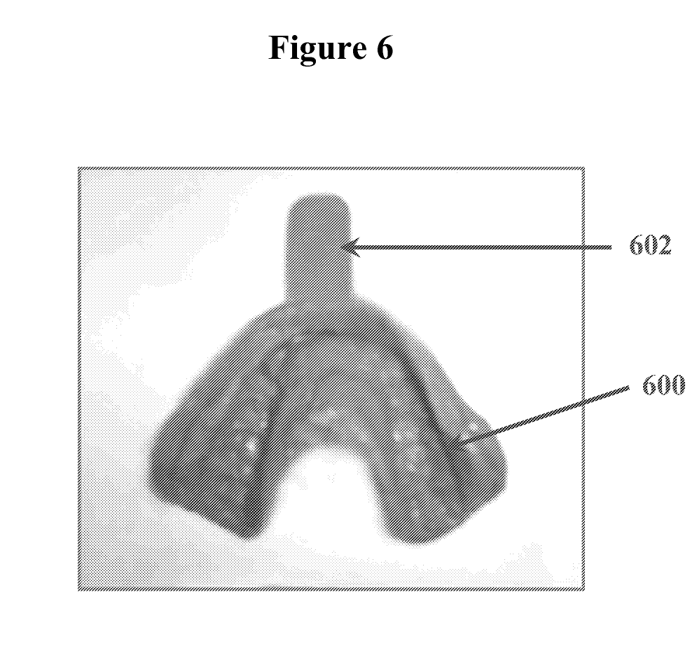

The entire process may also be done to the mandibular (lower) teeth. FIG. 6 illustrates an occlusal view of a mandibular impression 600 taken from a patient with anterior crowding. A mandibular impression 600 is an impression made of a patient's lower teeth. Anterior crowding is crowding of the front teeth. The mandibular impression 600 may be removed from the patient's mouth using tab 602.

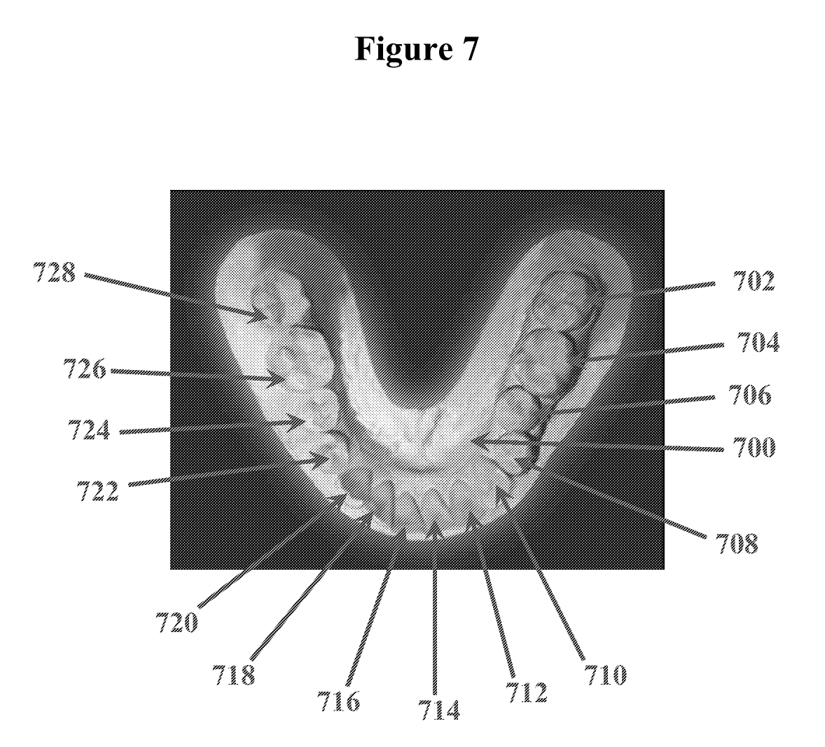

A mandibular stone model 700 of the patient's mandibular teeth may be made using the mandibular impression 600, as shown in FIG. 7. The mandibular stone model of the mandibular impression 600 may be modified to create an appliance that may alter and align the patient's teeth. FIG. 7 illustrates that the patient's teeth 702, 704, 706, 708, 710, 712, 714, 716, 718, 720, 722, 724, 726, 728 are not aligned.

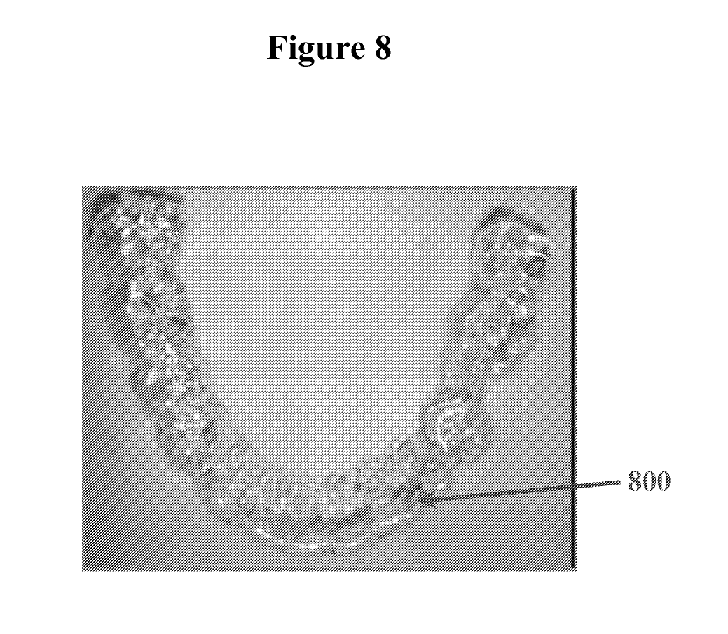

FIG. 8 illustrates a mandibular repositioning appliance 800 that may be fabricated from a mandibular stone model. The repositioning appliance 880 may be the first repositioning appliance in a series of appliances that may be used to reach the alignment goal. The repositioning appliance 800 may be comprised of a single sheet of material that may be formed from a variety of materials, such as polymers and plastics including polycarbonates, polyacetates, polyolefins, polyamides, polystyrenes and epoxy resins among others. These materials may range in thickness from 0.020 inch to 0.080 inch, depending upon the material's physical characteristics. In an aspect of the invention, the repositioning appliance 300 may be 0.030 inch thick polycarbonate with a lower modulus inner laminate which has been thermo vacuum-formed over a model 906 of a patient's teeth. The polycarbonate with a lower modulus inner laminate is tissue compatible and invisible which making it aesthetically appealing to the patient during its use. Those skilled in the art will realize that materials such as polycarbonates, polyacetates, polyolefins, polyamides, polystyrenes and epoxy resins among others may also be provided in clear forms. The 0.030 inch repositioning appliance 800 may be firm enough to move the patient's teeth and may be flexible enough to adapt to the patient's misaligned teeth. These characteristics provide a sequential adjustment of the teeth from a new impression at each and every phase toward the ideal that will move the patient's teeth from misalignment to alignment on an incremental basis with each and every new impression taken at each treatment interval of about six weeks. Those skilled in the art will realize that treatment intervals may be shorter or longer than six weeks depending upon a variety of patient and treatment factors.

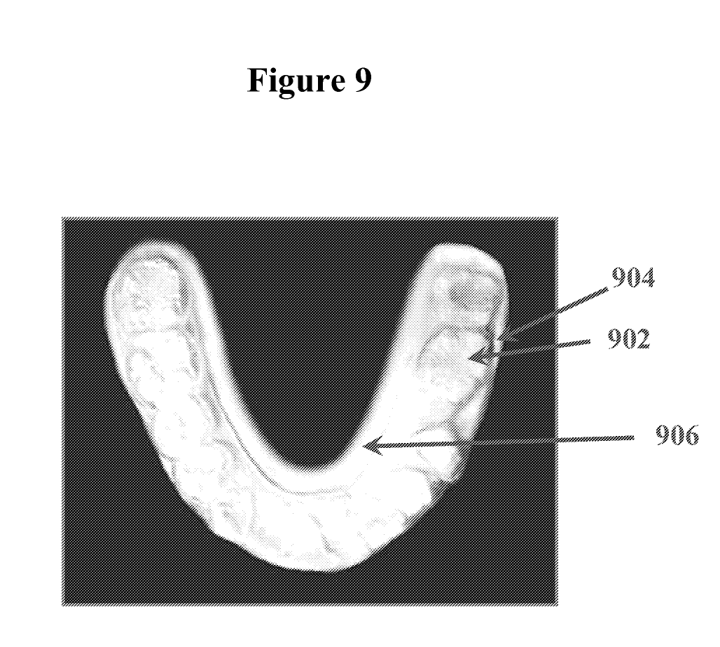

FIG. 9 illustrates mandibular repositioning appliance 800 over modified maxillary stone model 906. Repositioning appliance 800 may be formed over a patient's teeth 902 and adjacent soft tissue 904.

The process of taking a mandibular impression, creating a stone model therefrom, modifying that stone model into a more ideal alignment, and creating a mandibular repositioning appliance may occur at an interval of six weeks until the patient's teeth are in ideal alignment. Those skilled in the art will realize that the interval may be longer or shorter depending upon a variety of patient and treatment factors.

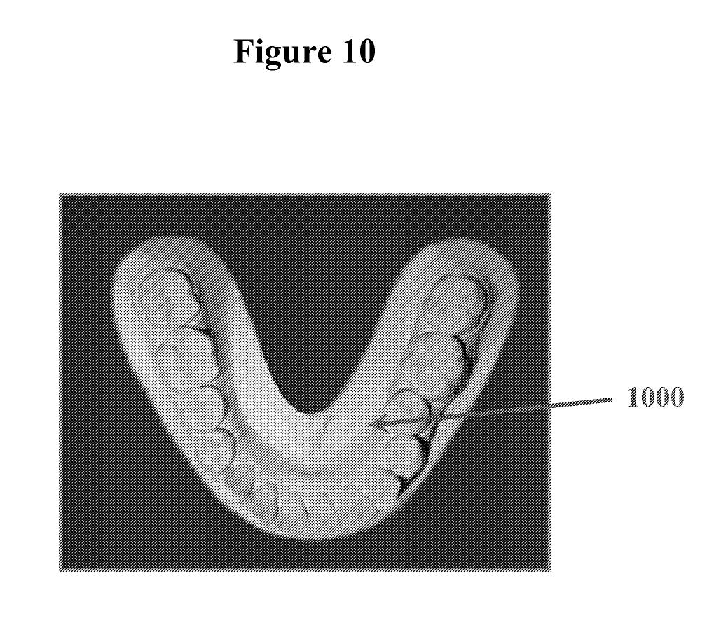

FIG. 10 illustrates a mandibular stone model 1000, which has been sequentially modified from an impression made subsequent to use of a number of repositioning appliances, each designed to increasingly align the patient's teeth. As seen on stone model 1000, the patient's teeth 702, 704, 706, 708, 710, 712, 714, 716, 718, 720, 722, 724, 726, 728 are much more aligned than they had been in the initial modified maxillary stone model 700. Mandibular stone model 1000 has been modified to a more ideal alignment, and it may be used to create a subsequent mandibular repositioning appliance.

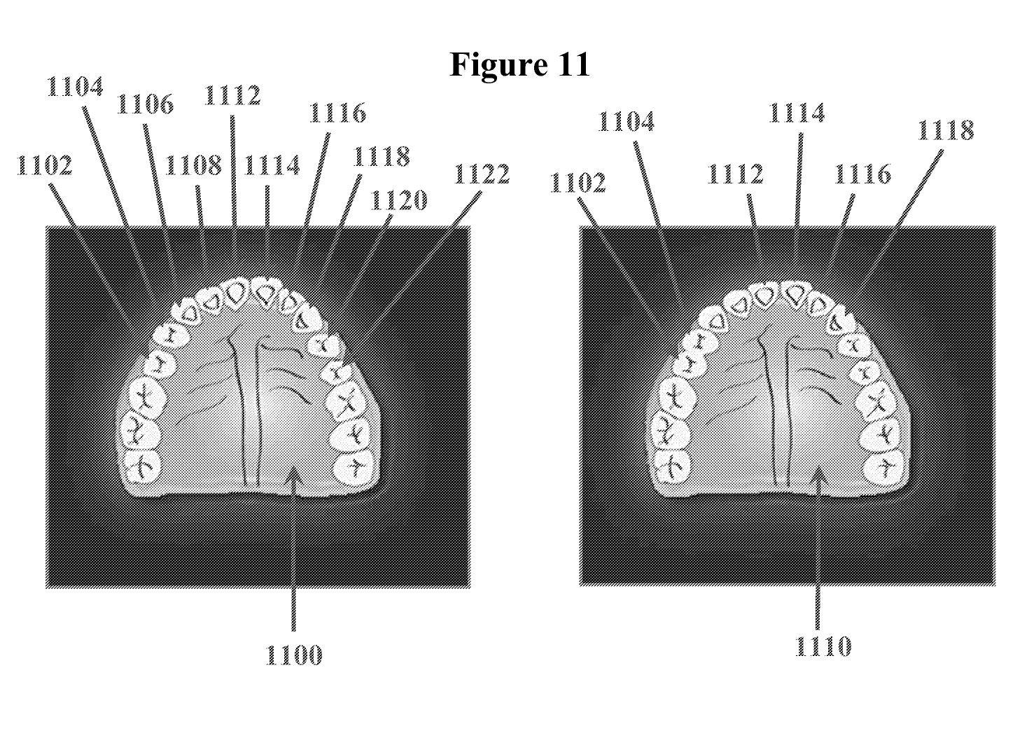

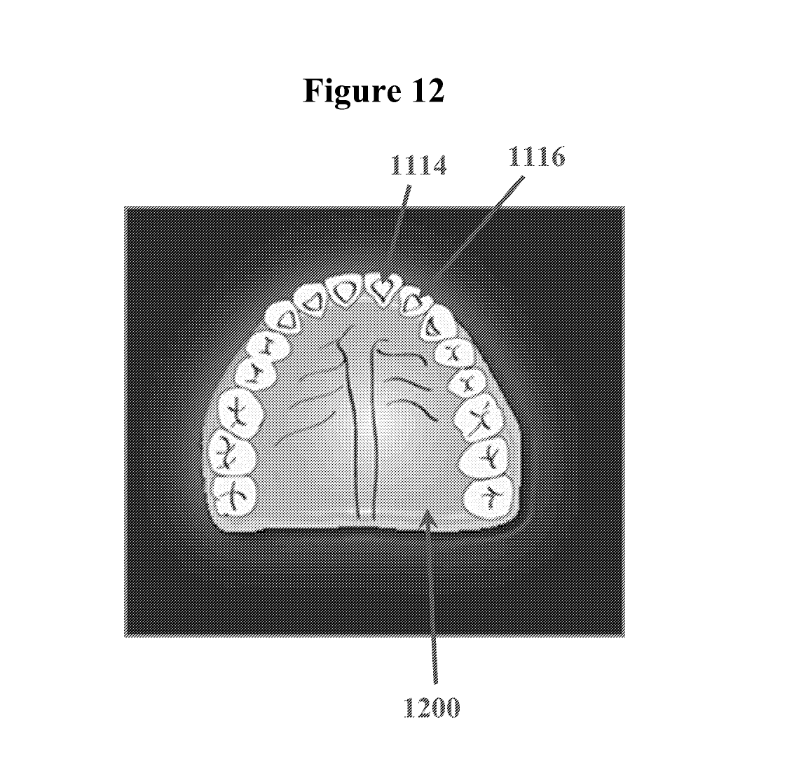

FIGS. 11 and 12 are diagrammatic views of a patient's maxillary teeth at sequential stages in the process of aligning the teeth to the ideal position. The diagram of the initial teeth 1100 shows unaligned teeth. Teeth 1102, 1104, 1106, 1108, 1112, 1114, 1116, 1118, 1120, 1122 are protruding and crooked. In the subsequent diagram 1110, the patient's teeth show improved alignment. The anterior incisor central teeth 1112, 1114 are less protruding, and anterior teeth 1102, 1104 are more aligned. Furthermore, anterior teeth 1116, 1118 show less overlap. In another more subsequent diagram 1200, the patient's teeth show further improvement. The teeth are in alignment and there is less overlap in anterior teeth 1114, 1116.

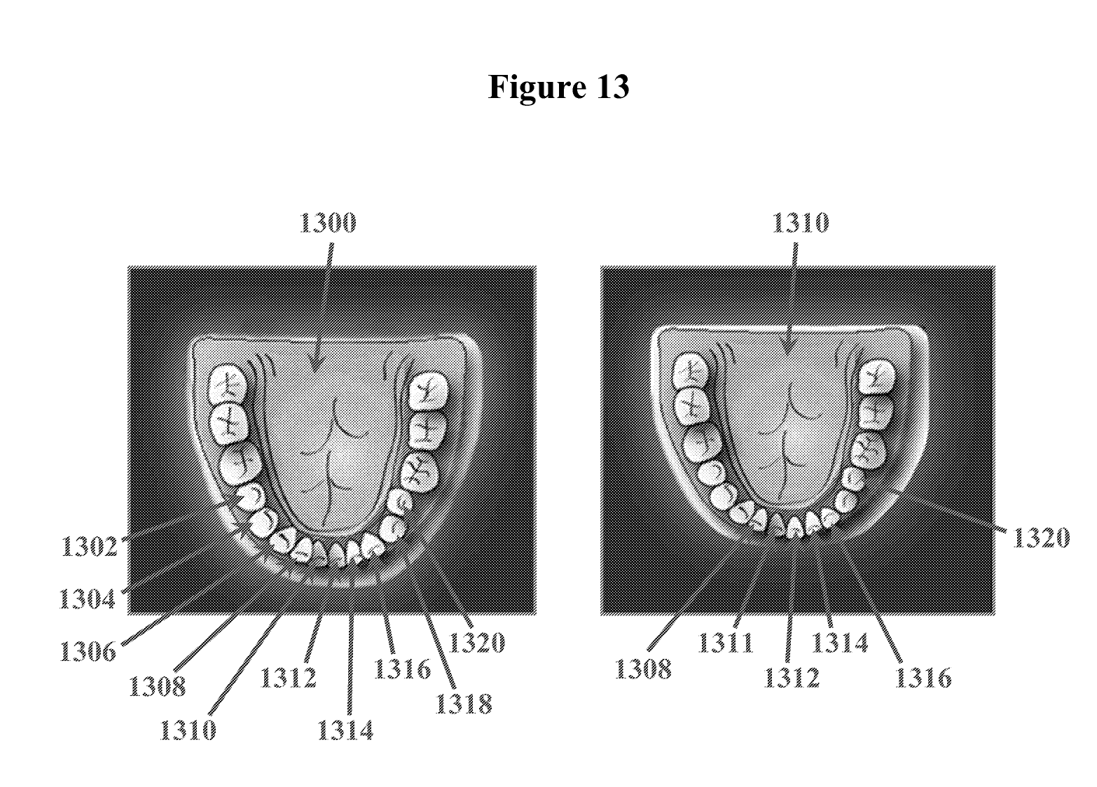

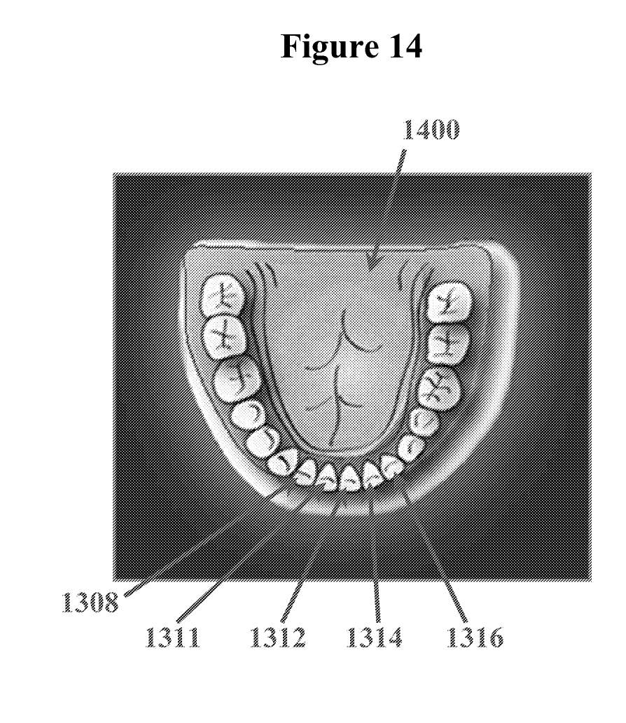

FIGS. 13 and 14 are diagrammatic views of a patient's mandibular teeth at sequential stages in the process of aligning the teeth to the ideal position. The diagram of the initial teeth 1300 shows unaligned teeth. Teeth 1302, 1304, 1306, 1308, 1311, 1312, 1314, 1316, 1318, 1320 are overlapping and crooked. In the subsequent diagram 1310, the patient's teeth show improved alignment. Teeth 1308, 1311, 1312, 1314, 1316 are less overlapping, and tooth 1320 is significantly more aligned with the other teeth. In another more subsequent diagram 1400, the patient's teeth show further improvement. The teeth are in alignment and there is even less overlap in teeth 1308, 1311, 1312, 1314, 1316.

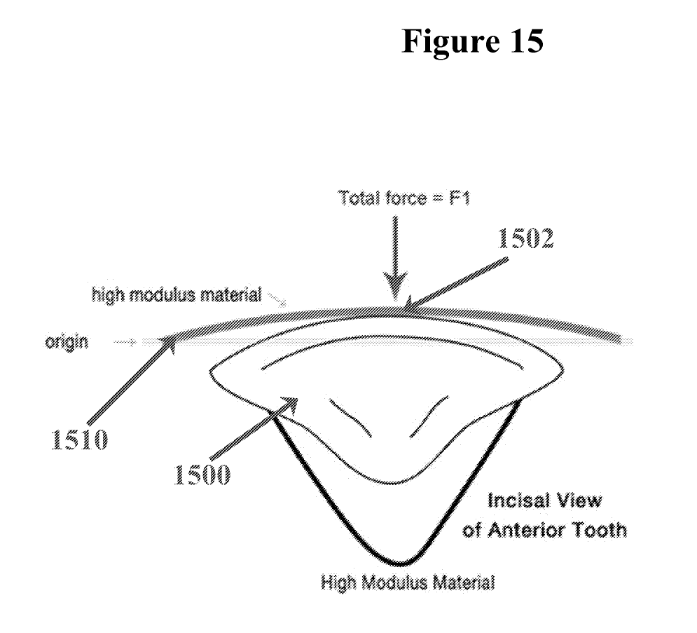

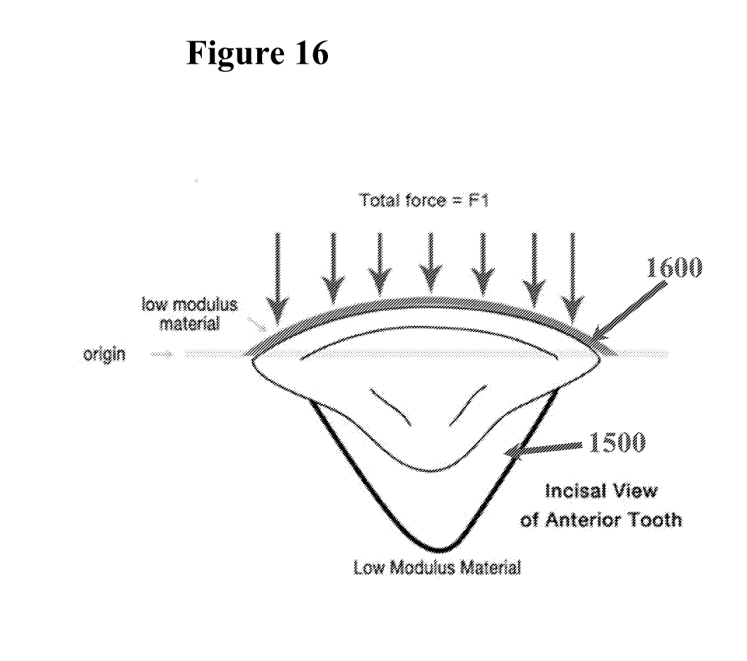

FIGS. 15 and 16 illustrate the benefits of having an inner layer with a lower elastic modulus than the outer layer. The elastic modulus of a material is the ratio of the increment of unit stress to an increment of unit deformation within the elastic limit. When a material is deformed within the elastic limit, the coiled polymer chains are stretched reversibly. The magnitude of the elastic modulus may be indicative of the atomic and molecular bonding forces. When the stress is relieved, the material returns to its original shape and therefore the deformation is nonpermanent. Different materials may have different elastic moduli based on their molecular structures. Some materials, such as certain polymers including polycarbonates, polyacetates, polyolefins, polyamides, polystyrenes and epoxy resins among others, may be specially produced to have different elastic moduli while retaining similar chemical compositions by using additives such as silicates, other polymers or fillers among other materials. In an embodiment, the liner may be a polymer such as Thermoplastic Polyurethane that is an aromatic polyether based grade, such as TEXIN® 990R resin with a shore hardness of approximately 90 A. The TEXIN® 990R resin may offer outstanding abrasive resistance, impact strength, toughness, structural memory and flexibility. Furthermore, the resin may also provide good hydrolytic stability, microbial resistance, and exceptional mold release characteristics.

In the final appliance the elastic moduli of the different parts will generally range from 0.1 to 10 GigaPascal (GPa), although some parts of the appliance may be outside of this range. The elastic modulus of one part may differ from another part by 10% to 500%, or more.

As shown in FIG. 15, if an appliance 1510 has a higher modulus on the inner layer than the outer layer, the pressure on the tooth 1500 is localized 1502, thereby increasing the propensity for tooth and bone damage. Also, the harder material 1510 is less elastic thereby causing greater load for a shorter period of time with less tooth movement by each appliance.

FIG. 16 demonstrates the effect on tooth 1500 with use of a repositioning appliance 1600 with an inner layer having a lower elastic modulus than the outer layer. The lower modulus inner layer repositioning appliance 1600 allows for the same amount of load to be distributed to a greater surface area of the tooth for less bone and root resorption. Additionally, the lower modulus inner layer repositioning appliance 1600 will give less force for a longer period of time. Therefore, not only is the lower modulus inner lining safer for the patient's teeth, but also, may allow the repositioning appliance to maintain a longer life.

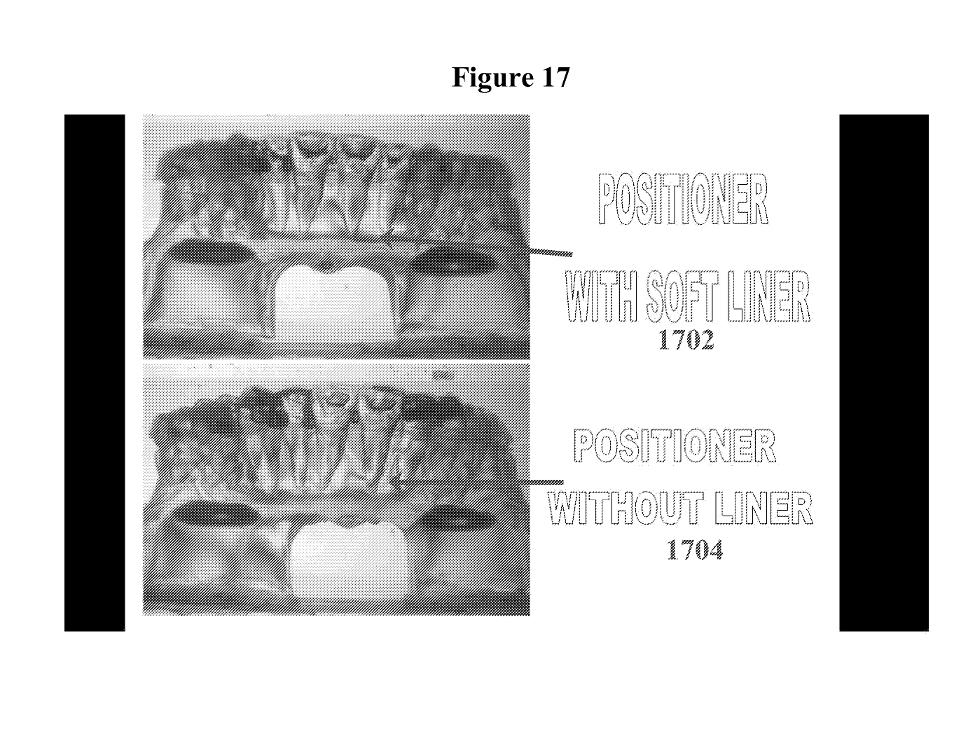

For example, FIG. 17 illustrates the stresses developed at a crestal bone between central incisors with repositioning appliance having an inner layer with a lower elastic modulus than the outer layer as compared to a repositioning appliance without an inner layer (liner).

Polyvinyl siloxane impressions were made and poured up in stone. The central incisors were modified to represent desired orthodontic movement. Two types of repositioning appliances were fabricated from the modified model. The first repositioning appliance was fabricated from a polycarbonate sheet. The second repositioning appliance was fabricated from a polycarbonate sheet laminated with lower modulus polyurethane. The laminated and un-laminated repositioning appliances were inserted on the model and resulting stresses observed in the field of the polariscope and photographed. Stress data for the two repositioning appliances was analyzed using a computer graphics program to quantify stress intensity by fringe number counting.

As shown in FIG. 17, similar stress distributions were developed at the crestal bone between the central incisors with both repositioning appliances. However, the level of stress was significantly lower using the laminated repositioning appliance 1702 as compared to the un-laminated repositioning appliance 1704.

The stresses associated with the laminated repositioning appliance were of lower intensity as compared to the un-laminated repositioning appliance, which may alleviate problems of patient discomfort and difficulty during insertion and removal of un-laminated repositioning appliances.

In another aspect of the invention relates to an invisible removable orthodontic repositioning appliance with an option to have incorporated in it Shape Memory Alloy (SMA) which is an alloy where once the material shape is set the material may be severely deformed and then returned to its original shape. In an embodiment, the SMA may be adapted to an idealized dental alignment and then realigned to the present misaligned dental position and adhered to the polymeric orthodontic shell to allow continual inherent movement of the teeth or adjusted by the dentist. SMA and polymeric technology may allow for two types of cooperating forces toward optimal tooth movement. SMA may be utilized under conditions needing greater force, more rapid movement and or severe cases.

In an aspect of the invention, orthodontic shape memory alloy wire having properties may be adapted to the lingual aspect of a stone model prior to adaptation of the repositioning appliance 1600 thereby allowing continual inherent movement of the patient's teeth. The orthodontic wire may be comprised of an alloy having shape memory properties such as NiTi, CuZnAl, and CuAlNi. Moreover, the orthodontic wire may be adjusted to assist in repositioning of teeth to an optimal position. This adjustment may be a self adjustment or an adjustment based on temperature change.

In yet another aspect of the invention, a micro-implant which may be approximately 1-5 mm in diameter may be utilized. The micro-implant may withstand immediate load unlike traditional implants which may require 6 months of bone integration (healing). The micro-implant may be attached or connected to the polymeric shell or a component of the shell for added orthodontic tooth movement. Micro-implant for orthodontic movement may be achieved by either attachment for example using a Hader-bar, male-female (ball and socket) or magnets to allow for greater force and greater control of orthodontic forces. This may allow for greater options under various orthodontic conditions. A technique for greater orthodontic force and or control may be with magnet attachment at the head (coronal aspect of the micro-implant). The micro-implant may be positioned with the positive pole of the magnet positioned into the bone or tooth for anchorage. The negative pole of the magnet may be imbedded into the SMA, a bracket or component of the polymeric shell or the polymeric matrix of the appliance to allow for greater control and force for orthodontic tooth movement.

In a further aspect of the invention, the repositioning appliance may comprise bars for greater control and attachment over a patient's teeth. For example, placement of grooves on a patient's stone model which translates into bars on the appliance upon replication may be used in areas which require greater control and force.

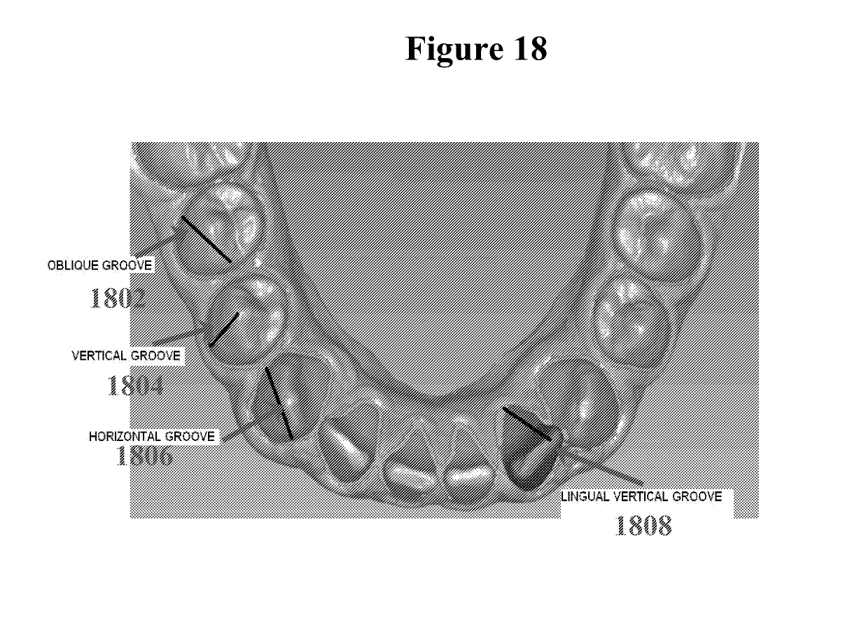

FIG. 18 illustrates the placement of various grooves such as an oblique groove 1802, a vertical groove 1804, a horizontal groove 1806, and a lingual vertical groove 1808. Those skilled in the art will realize that other geometric shaped grooves such as longitudinal, diagonal, or horizontal grooves may also be used depending upon the type of orthodontic movement. Upon fabrication of the appliance, the grooves may become extensions on the appliance to allow for greater control during orthodontic tooth movement.

Placement of the grooves on a stone model which translate into bars on the appliance as compared to cementing brackets on patient's teeth may eliminate the need for invasive attachments to teeth such as clasps +/or brackets. In addition, the bars may eliminate propensity for damage to teeth during application of cement or during grinding of the brackets during removal. Moreover, the grooves may provide improved esthetic and greater ease of oral hygiene for the patient.

I claim:

1. An orthodontic repositioning appliance comprising:
a) an inner layer configured to engage a portion of a patient's teeth; and
b) an outer layer attached to the inner layer, the outer layer having a higher elastic modulus than the inner layer.

2. The orthodontic repositioning appliance of claim 1, wherein the inner layer and outer layer comprise elastic moduli in the range of 0.1 to 10.0 GPa.

3. The orthodontic repositioning appliance of claim 1, wherein the outer layer comprises a polycarbonate.

4. The orthodontic repositioning appliance of claim 1, wherein the inner layer comprises a thermoplastic polyurethane resin.

5. The orthodontic repositioning appliance of claim 1, further comprising a shape memory alloy.

6. The orthodontic repositioning appliance of claim 1, further including a micro-implant attached to the repositioning appliance to allow for increased control and force for orthodontic tooth movement.

7. The orthodontic repositioning appliance of claim 6, wherein the micro-implant further includes a magnet.

8. The orthodontic repositioning appliance of claim 1, wherein the inner and outer layer comprise bacterial resistant materials.

9. The orthodontic repositioning appliance of claim 1, wherein the outer layer includes at least one groove providing increased control and attachment over the portion of the patient's teeth.

10. The orthodontic repositioning appliance of claim 9, wherein the at least one groove comprises a lingual vertical groove.

11. The orthodontic repositioning appliance of claim 9, wherein the at least one groove comprises a horizontal groove.

12. The orthodontic repositioning appliance of claim 9, wherein the at least one groove comprise a diagonal groove.

13. The orthodontic repositioning appliance of claim 1, wherein the inner layer comprises a continuous layer having a lower elastic module than the outer layer.

14. A method of repositioning teeth from an initial tooth position to a final tooth position, the method comprising:
a) taking an impression of the teeth to be repositioned;
b) creating a model from the impression;
c) modifying the model to incorporate the final tooth position; and
d) creating a repositioning appliance from the model, the repositioning appliance including an inner layer configured to engage a portion of a patient's teeth and an outer layer attached to the inner layer, the outer layer having a higher elastic modulus than the inner layer.

15. The method of claim 14, wherein the repositioning appliance is created using a 3-D scanner and printer.

16. The method of claim 14, further comprising e) repeating steps a) through d) at periodic intervals.

17. The method of claim 16, wherein the periodic interval comprises six weeks.

18. The method of claim 14, wherein the wherein the outer layer comprises a polycarbonate.

19. The method of claim 14, wherein the inner layer comprises a thermoplastic polyurethane resin.

20. An orthodontic repositioning appliance comprising a laminar shell including an inner layer and an outer layer, the inner layer configured to engage a portion of a patient's teeth and an outer layer attached to the inner layer, the inner layer having a lower elastic modulus than the outer layer.
